(19) United States
(12) Patent Application Publication
(10) Pub. No.: US 2023/0183542 A1
(43) Pub. Date: Jun. 15, 2023

(54) LOW VISCOSITY THERMALLY CONDUCTIVE PASTE

(71) Applicant: Henkel AG & Co. KGaA, Duesseldorf (DE)

(72) Inventors: Matthew Ahearn, Union, NJ (US); Stanley Shengqian Kong, Hillsborough, NJ (US)

(21) Appl. No.: 18/105,332

(22) Filed: Feb. 3, 2023

Related U.S. Application Data
(63) Continuation of application No. PCT/US2021/071088, filed on Aug. 3, 2021.
(60) Provisional application No. 63/060,179, filed on Aug. 3, 2020.

(51) Int. Cl. C09K 5/14; C08K 3/20; C08K 5/095; C08K 5/42; C08K 5/5313; C08L 83/04

(52) U.S. Cl. CPC C09K 5/14; C08K 3/20; C08K 5/095; C08K 5/42; C08K 5/5313; C08L 83/04; C08K 2003/2227

(57) ABSTRACT

The invention is based on the novel use of Aluminum Trihydroxide (ATH or Al(OH)₃) as a filler for Thermal Interface Materials (TIM).

### BACKGROUND

Traditional fillers for Thermal Interface Materials (TIM or TIMs) use alumina powder (Al₂O₃) which has high thermal conductivity (20-30 W/m·K). However, aluminum oxide thermal fillers typically have density values close to 4.0 g/cm³. This makes the TIM heavy in application areas such as electrical vehicles, where a lot of TIMs are used. Compared to aluminum oxide, Aluminum Trihydroxide (ATH) has much lower density around 2.4 g/cm³. Due to irregular shape and polar surface groups, ATH is very difficult to formulate at high loading to provide sufficient thermal conductivity due to high viscosities. In addition, a reliable thermal conductivity value of this material has rarely been reported.

### SUMMARY

The present invention describes how ATH can be used as an alternative for TIM applications. Provided are compositions including ATH which can be used as an alternative for TIM applications, such as TIM for EV batteries. The compositions of the present invention including ATH advantageously have 1) acceptable, workable viscosities and dispensing rates and 2) have measurable thermal conductivities. The compositions of the present invention are advantageously fully curable. Compositions are provided with up to 80-85% by wt. ATH and 15-20% by wt. resin that have 1) acceptable viscosities and dispensing rates and 2) usable thermal conductivities.

A thermally conductive composition as described herein is a gap filler for thermal interface materials targeted at EV batteries. The compositions of the present invention are a cheaper alternative to thermally conductive pastes known in the art. A thermally conductive composition including a silicone or silicone-hybrid resin matrix is provided. A conductive filler including an aluminum oxide-containing particle is included in the thermally conductive composition. As used herein, the term “aluminum oxide-containing particle” includes aluminum oxide (aka alumina), aluminum hydroxide, polymorphs of aluminum hydroxide and Boehmite. Boehmite or böhmite is an aluminium oxide hydroxide (γ-AlO(OH)) mineral. Four polymorphs of aluminium hydroxide exist, all based on the common combination of one aluminium atom and three hydroxide molecules into different crystalline arrangements that determine the appearance and properties of the compound. The four polymorphs, i.e., combinations are Gibbsite, Bayerite Nordstrandite and Doyleite. Aluminum hydroxide polymorphs that can be used in the compositions, methods, and systems disclosed herein are described in Violante and Huang, Formation Mechanism of Aluminum Hydroxide Polymorphs, Clays and Clay Minerals, Vol. 41, No. 5, 590-597 (1983), the entire contents of which are incorporated by reference herein, available at http://citeseerx.ist.psu.edu/viewdoc/download?doi=10.1.1.460.7629&rep=rep1&type=pdf. The conductive filler can be dispersed throughout the silicone or silicone-hybrid resin matrix to provide thermal conductivity. The thermally conductive composition further includes a liquid organic acid which is soluble in the matrix. The thermally conductive composition may be used as a TIM, such as a TIM for EV batteries.

In one embodiment, the present invention provides a thermally conductive composition including:
(a) a silicone or silicone-hybrid resin matrix;
(b) a conductive filler including an aluminum oxide-containing particle; and
(c) a liquid organic acid soluble in the matrix.

In another embodiment, the present invention provides a method for making a thermally conductive composition including providing:

(a) a silicone or silicone-hybrid resin matrix;
(b) a conductive filler including an aluminum oxide-containing particle; and
(c) a liquid organic acid soluble in the matrix.

In yet another embodiment, the present invention provides a reaction product of a thermally conductive composition including:
(a) a silicone or silicone-hybrid resin matrix;
(b) a conductive filler including an aluminum oxide-containing particle; and
(c) a liquid organic acid soluble in the matrix.

Another embodiment of the present invention provides an device containing a heat source, a heat sink and a TIM prepared from a thermally conductive composition of the present invention. The device can be a battery.

### BRIEF DESCRIPTION OF THE FIGURES

FIG. 1 is uPAO-SiH Model Reaction.

FIG. 2 shows a comb structure created by grating a compound comprising one unsaturated olefin having vinyl functionality located at the terminal end(s) or pendent on the compound (mono-vinyl polydimethylsiloxane (PDMS)) to a compound comprising at least one silicon hydride functional group (methylhydridosiloxane-dimethylsiloxane copolymer).

FIG. 3A shows a comparative composition.

FIG. 3B shows an inventive composition.

FIG. 4A shows a comparative composition.

FIG. 4B shows an inventive composition.

FIG. 5A shows a comparative composition.

FIG. 5B shows an inventive composition.

### DETAILED DESCRIPTION

Unless otherwise defined, all technical and scientific terms used herein have the same meaning as commonly understood by one of ordinary skill in the art. In case of conflict, the definitions set forth in this document will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used in the specification and in the claims, the terms “including” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, a resin, oligomer or monomers are used interchangeably here in the invention.

Acrylate is broadly defined as including acrylates, substituted acrylate, e.g., (meth)acrylates.

As used herein, the term “vinyl” (or ethenyl) refers to the functional group with the formula —CH═CH₂. Accordingly, vinyl (or ethenyl) is the functional group with the formula —CH═CH₂.

As used herein, the term “vinylidene” refers to compounds with the formula >C═CH₂, where >, in >C═CH₂, represents two identical or different hydrocarbon substituents. The substituents can be aliphatic or aromatic, and may contain unsaturation and/or heteroatoms. As used herein, the term, “vinylidene” includes terminal olefins such as those disclosed in US Pat. Pub. No. 2019/0248936 A1 (ExxonMobil Chemical Patents, Inc.) and US Pat. Pub. No. 2019/0359745 A1 (ExxonMobil Chemical Patents, Inc.), the entire contents of which are incorporated by reference herein. Suitable vinylidene compounds for use in the compositions, adducts, systems, methods and reactions disclosed herein include not only mPAOs, but also mono-methacrylates and multifunctional methacrylates.

As used herein, the term “vinylene” refers to —CH═CH—.

A thermally conductive composition as described herein includes a silicone or silicone-hybrid resin matrix. The matrix may be a silicone-hybrid that is curable or non-curable. When the resin is not curable, a filled composition or system is a thermal paste/thermal grease. When the resin is curable, it can form a gap pad or cure-in-place reactive gap filler. The silicone-hybrid resin of the silicone-hybrid resin matrix may be a silicone-hybrid resin as described herein.

The silicone hybrid resin may be formed by combining two parts having vinyl or vinylidene or vinylene and/or silicon hydride functionality. When the silicone hybrid resin is formed form two parts, one or both parts comprises a compound having vinyl or vinylidene functionality located at the terminal end(s) or pendent on the compound or vinylene functionality terminal, pendent or internal of the main chain of the compound. One of those parts further comprises a compound comprising at least one silicon hydride functional group and the other part further comprises a crosslinker component and a hydrosilation catalyst. Typically, the compound including at least one silicon hydride functional group remain in a separate part from the crosslinker component and the hydrosilation catalyst until combined together to form the silicone hybrid resin.

The crosslinker component can be mixed with silicone hydride component or the hydrosilation catalyst component to balance volume of Part A and Part B.

It has been determined that where a silicone hybrid resin matrix as described herein is used, a thermally conductive composition as described herein: (1) has negligible silicone resin; (2) has no leachable resin(s) such as leachable resins including cyclic siloxane compounds and/or floating/unreacted siloxanes; (3) has a high dispensing rate; and (4) is thermally stable from about −40° C. to 80° C. The bleeding of leachable resins including cyclic siloxane compounds, which are low molecular weight compounds, is a common problem for TIMs based on silicone resins. The novel hybrid composition disclosed herein solves this issue since all cylic siloxanes are reacted with the uPAO. Thus, all leachable resins, cylic siloxanes and/or floating/unreacted siloxanes are no longer in the system. Not all silicone hybrid systems can achieve advantages such as negligible silicone resin and no leachable resin. These are all advantages of the compositions of the present invention which include a silicone hybrid resin matrix. It has been found that by reacting PDMS with a uPAO having a high vinylidene content, the bleeding which typically occurs with the use of PDMS can be avoided. The compositions of the present invention can thus advantageously provide for high conversion, high temperature resistance and no bleeding at lower cost than conventional compositions not made by reacting PDMS with a uPAO, making them particularly useful for use as TIMs in electronic devices such as, for example, batteries.

When a silicone hybrid resin is used, a composition comprising a silicone hybrid resin is provided. The silicone hybrid resin is prepared from two parts, and upon mixing the two parts, the silicone hybrid resin is cured. A thermally conductive filler or a plurality of thermally conductive fillers is/are added and dispersed throughout the silicone hybrid resin to provide thermal conductivity, which may be used as a TIM.

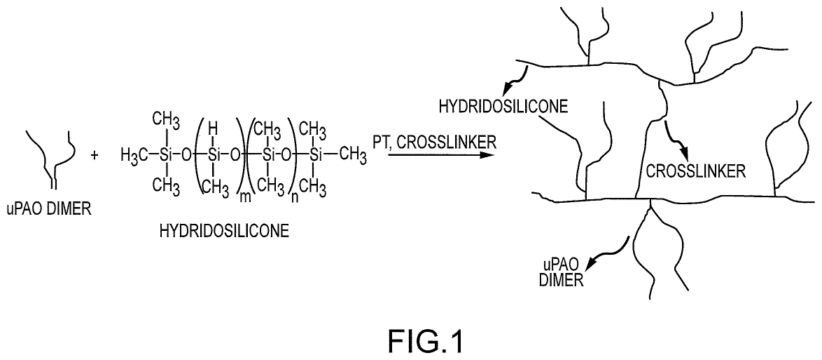

The silicone hybrid resin has a predominantly comb-like network structure, and may be formed by reacting a compound comprising one unsaturated olefin (“the comb”) having vinyl or vinylidene functionality located at the terminal end(s) or pendent on the compound or having vinylene functionality terminal, pendent or internal of the main chain of the compound, the compound having an average molecular weight of at least about 100 up to about 10,000, a compound comprising at least one silicon hydride functional group (—SiH), a crosslinker component comprising at least two vinyl groups, and a hydrosilation catalyst. The comb-like network structure has a hydrido-silicone backbone. A side chain, comb portion of network structure (the “comb”), is formed from an unsaturated polyalphaolefin (uPAO) or other mono-unsaturated compounds. Where a uPAO is used to make the silicone hybrid resin, the silicone hybrid resin is a uPAO-silicone hybrid resin. Preferably, the compound comprising at least two silicon hydride functional groups has a siloxane backbone. A uPAO-SiH model reaction is shown in FIG. 1.

For those skilled in the art, it is understandable that the final structure is idealized and other addition structure variations may exist.

As used herein, the term “comb” refers to a compound with at least one double bond having a long chain with molecular weight (MW) of at least about 100 up to about 10,000 daltons, and is the same as a “comb material” and a “comb compound.” The comb is generally a small molecule. When the comb is a polymer, it has a number average molecular weight of about 500 up to about 10,000. The comb may be a compound including one unsaturated olefin having vinyl or vinylidene functionality located at the terminal end(s) or pendent on the compound or, alternatively, the comb may be a vinylene compound including one or multiple internal double bonds —CH═CH—.

It will be understood that where a compound comprising one unsaturated olefin having vinyl or vinylidene functionality located at the terminal end(s) or pendent on the compound is disclosed for use in compositions, systems, methods and reactions herein, a compound comprising internal double bonds that are not vinylidene may alternatively be used. An example of a suitable compound comprising internal double bonds that are not vinylidene is vegetable oil. Methyl oleate (MW 296), which comes from renewable sources, may be used as the comb.

Suitable compounds comprising internal double bonds that are not vinylidene include vinylene compounds with one or multiple internal double bonds. Accordingly, a vinylene compound with one or multiple internal double bonds —CH═CH— may be used instead of the compound comprising one unsaturated olefin having vinyl or vinylidene functionality located at the terminal end(s) or pendent on the compound as the comb material. Thus, a vinylene compound with one of more multiple internal double bonds —CH═CH— may be used with a compound comprising at least one silicon hydride functional group (“SiH compound”) instead of using the compound comprising one unsaturated olefin having vinyl or vinylidene functionality located at the terminal end(s) or pendent on the compound with the SiH compound. It also will be understood that a compound comprising one unsaturated olefin having vinyl or vinylidene functionality located at the terminal end(s) or pendent on the compound as disclosed herein may include one or multiple internal double bonds —CH═CH—. The compound including one or multiple internal double bonds —CH═CH— may have an average molecular weight of at least about 100 up to about 10,000. An example of a vinylene compound comprising one internal double bond —CH═CH— for use in the compositions, systems, methods and reactions disclosed herein is methyl oleate (molecular weight (MW) 296), which has the double bond located in the middle of the chain. An example of a vinylene compound comprising one internal bond —CH═CH— for use in the compositions, adducts, systems, methods and reactions disclosed herein is an ether or ester derivative of crotyl alcohol (for example, crotyl octyl ether), which has the double bond located at the terminal end of the chain. An example of a compound having multiple internal double bonds for use in the compositions systems, methods and reactions disclosed herein is high oleic soybean oil (molecular weight (MW) of about 880), which is a polyunsaturated triglyceride. Accordingly, the vinylene compound including one or more multiple internal double bonds —CH═CH— may be a renewable resource, such as methyl oleate (MW 296) or high oleic soybean oil (MW of about 880). Other examples include palm oil, soybean oil, rapeseed/canola oils, linseed oil, castor oil, sunflower oil, to name just a few.

The silicone hybrid resin may be formed by combining two separate parts: Part A and Part B. Parts A and B each comprise an uPAO. At least one of Parts A and B comprise an uPAO. uPAO can be in either Part A or in Part B or both. Desirably, Parts A and B each contain an uPAO. One of Parts A and B further comprises a compound comprising at least one silicon hydride functional group and the other of Parts A and B comprises a crosslinker component and a hydrosilation catalyst, which also is referred to as a hydrosilylation catalyst herein. Hydrosilation is the addition of Si—H bonds across unsaturated bonds. It is also called hydrosilylation. The terms hydrosilation catalyst and hydrosilylation catalyst are used interchangeably herein. Crosslinker components can be in either A, or B, or both, as long as hydrosilation catalyst is separated from silicon hydride component. Typically, a crosslinker and catalyst are loaded with the uPAO to form one part and a hydridofunctional siloxane and residual uPAO form the other part. When two separate parts are used, it is important to keep the compound comprising the silicon hydride functional group separate from the crosslinker component and the hydrosilation catalyst so that they do not react prematurely. Upon mixing the two parts, both parts react to form the comb-like structure. It is preferred that at least one of the Part A or Part B further comprises a thermally conductive filler or a plurality of thermally conductive fillers. Desirably, Parts A and B both contain a majority of thermally conductive fillers. Although the silicone hybrid resin is preferably formed from two parts, it also may be formed from a one part composition.

The compositions methods and reactions of the present invention may include any suitable polyalphaolefin (PAO), produced by Chevron Phillips, ExxonMobil, INEOS, Lanxess, etc. The PAO can be saturated or unsaturated. Saturated PAOs are generally made through hydrogenation of unsaturated PAOs. As used herein, the term “PAO” is a general term and automatically includes uPAO. A compound for use in the compositions, systems, methods and reactions of the present invention may be a PAO which is saturated or unsaturated. When a saturated PAO is incorporated, it will behave as a plasticizer in the cured material.

The compositions of the present invention may include any suitable unsaturated polyalphaolefin (uPAO). A suitable uPAO is a compound comprising one unsaturated olefin having vinyl or vinylidene functionality located at the terminal end(s) or pendent on the compound or vinylene functionality terminal, pendent or internal of the main chain of the compound. Such a compound is hereinafter referred to as “unsaturated olefin compound” or as “unsaturated uPAO,” which terms are used interchangeably herein. When an unsaturated PAO is used, it will be incorporated into the resin matrix through chemical reaction and bond formation. When the uPAO comprises vinylidene, the uPAO is vinylidene PAO. Among all monofunctional PAO compounds having a C═C double bond of any kind, a monofunctional PAO for use in the compositions, systems, methods and reactions disclosed herein may have a lower limit of 10 mol % vinylidene when the monofunctional PAO comprises vinylidene. The uPAO suitable for use in the compositions, methods and reactions disclosed herein may be “high vinylidene uPAOs”. When the uPAO is a high vinylidene uPAO, the uPAO will have over 50 mol % vinylidene, more preferably over 80 mol %, and still more preferably over 95 mol %, and 100 mol % vinylidene can be the upper limit. Accordingly, the uPAO may comprise vinylidene in an amount from about 10 mol % to about 100 mol %, from about 50 mol % to about 100 mol %, from about 80 mol % to about 100 mol %, or from about 95 mol % to about 100 mol % of the uPAO.

The unsaturated olefin compound may have any suitable average molecular weight. The unsaturated olefin compound may have an average molecular weight selected from: greater than about 100; greater than about 200; greater than about 6,000; greater than about 16,000. It is useful when the unsaturated olefin compound has an average molecular weight of at least about 100 up to about 10,000. Particularly, the average molecular weight can be from about 100 to about 1000, and more preferably, from about 100 to about 500. The average molecular also can be, for example, greater than about 100 and less than about 1,000; greater than about 200 and less than about 1,000; greater than about 100 and less than about 500; and greater than about 200 and less than about 500.

The compositions of the present invention may include any suitable unsaturated polyalphaolefin (uPAO).

The unsaturated olefin compound can be an unsaturated polyalphaolefin prepared with a metallocene catalyst (mPAO). Different grades of unsaturated PAOs are available, depending on their nominal KV100, cSt (KV is kinematic viscosity). The uPAO can also by prepared using a traditional catalyst. Desirably, the unsaturated olefin compound is an unsaturated polyalphaolefin prepared using a metallocene catalyst (mPAO). uPAOs prepared by using a traditional catalyst are less desirable as they have more branching.

An unsaturated poly alpha olefin molecule which is polymeric, typically oligomeric, produced from the polymerization reactions of alpha-olefin monomer molecules (generally C₆ to about C₂₀olefins) in the presence of a catalyst system given by the general structure (F-1) may be used.

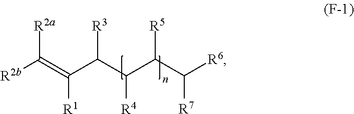

where R¹, R^{2a}, R^{2b}, R³, each of R⁴ and R⁵, R⁶, and R⁷, the same or different at each occurrence, independently represents a hydrogen or a substituted or unsubstituted hydrocarbyl (such as an alkyl) group, and n is a non-negative integer corresponding to the degree of polymerization. Where R¹, R^{2a} and R^{2b} are all hydrogen, (F-1) represents a vinyl PAO; where R¹ is not hydrogen, and both R^{2a} and R^{2b} are hydrogen, (F-1) represents a vinylidene PAO; where R¹ is hydrogen, and only one of R^{2a} and R^{2b} is hydrogen, (F-1) represents a disubstituted vinylene PAO; and where R¹ is not hydrogen, and only one of R^{2a} and R^{2b} is hydrogen, then (F-1) represents a trisubstituted vinylene PAO. Where n=0, (F-1) represents an PAO dimer produced from the reaction of two monomer molecules after a single addition reaction between two C═C bonds.

When n=0, the unsaturated poly alpha olefin molecule has the structure:

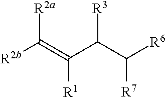

where R¹, R^{2a}, R^{2b}, R³, R⁶ and R⁷ are as defined above and where
R¹+R^{2a}+R^{2b}+R³+R⁶+R⁷ combined has an even number of saturated hydrocarbons ranging from 8 to about 36 carbons.

Suitable uPAOs include those supplied by ExxonMobil. Preferably, high vinylidene uPAOs prepared with selected metallocene catalysts as disclosed in US Pat. Pub. No. 2019/0248936 A1 (ExxonMobil Chemical Patents, Inc.) and US Pat. Pub. No. 2019/0359745 A1 (ExxonMobil Chemical Patents, Inc.), the entire contents of both of which are incorporated by reference herein. These materials have a residual olefin in the terminal position of the polymer backbone, with examples of unsaturated poly alpha olefin molecules having a residual olefin in the terminal position of the polymer backbone including the unsaturated poly alpha olefin molecules referred to in the following examples (i.e., F-1-a, F-1-b, F-1-c and F-1-d):

The unsaturated poly alpha olefin molecule may be an unsaturated metallocene derived α-olefin dimer, obtained from ExxonMobil, and referred to as F-1-a herein.

The unsaturated poly alpha olefin molecule may be unsaturated metallocene derived α-olefin oligomers with approximate Kinematic Viscosity @ 100° C. of about 40 cSt, obtained from ExxonMobil, and referred to as F-1-b herein.

The unsaturated poly alpha olefin molecule may be ExxonMobil™ Intermediate u65 with approximate Kinematic Viscosity @ 100° C. of 65 cSt, supplied by ExxonMobil, and referred to herein as F-1-c.

The unsaturated poly alpha olefin molecule may be ExxonMobil™ Intermediate u150 with approximate Kinematic Viscosity @ 100° C. of 150 cSt, supplied by ExxonMobil, and referred to herein as F-1-d.

Preferably, the unsaturated poly alpha olefin molecule is F-1-c or F-1-d. More preferably, the unsaturated poly alpha olefin molecule is F-1-a or F-1-b.

The unsaturated olefin compound may be selected from monovinyl silicones, unsaturated monofunctional olefins and polyolefins, (meth)acrylates, alkenyl functional ethers, esters, carbonates and mixtures thereof. Particularly, the unsaturated olefin compound is selected from one or more mono-vinyl polydimethyl siloxanes (PDMS). The unsaturated olefin compound may be selected from an unsaturated α-olefin dimer, an alkyl 3,3-dimethyl-4-pentenoate, an alkyl-10-undeconoate, an alkyl methacrylate, an alkyl acrylate, an alkyl 3,3-dimethyl-4-pentenoate, styrene, 3-ethyl-3-oxetanylmethyl 3,3-dimethyl-4-pentanoate, ally ester of linear or branched iso-steric acid and mixtures thereof. More particularly, the unsaturated olefin compound is selected from an unsaturated α-olefin dimer, lauryl 3,3-dimethyl-4-pentenoate, butyl 10-undeconoate, dodecyl methacrylate, tridecyl acrylate, dodecyl 3,3-dimethyl-4-pentenoate, styrene, 3-ethyl-3-oxetanylmethyl 3,3-dimethyl-4-pentanoate, ally ester of linear or branched iso-steric acid and mixtures thereof.

More than one unsaturated olefin compound can be used to prepare the silicone-hybrid resin. For example, a curable composition may include an unsaturated α-olefin oligomer and an unsaturated α-olefin dimer. For a two-part composition, an unsaturated olefin compound may be in each part. A one-part composition also may include more than one unsaturated olefin compound. A curable one part composition may include a mono-vinyl polydimethyl siloxane (PDMS) having an average molecular weight of greater than about 6,000 and a mono-vinyl siloxane (PDMS) having an average molecular weight greater than about 16,000, such as 16,666.

The unsaturated olefin compound is desirably flowable at room temperature.

The unsaturated olefin compound is desirably made from about 6 to about 20 carbon atoms.

The unsaturated olefin compound may have a viscosity from about 10 cps to about 100 cps. The unsaturated olefin compound may have a viscosity less than about 125 cps. The unsaturated olefin compound also may have a viscosity from about 125 cps to about 3500 cps. Viscosities are measured with a Brookfield CAP 2000+ viscometer at room temperature.

The unsaturated olefin compound may be present in amounts of about 1% to about 80% by weight of the total resin composition. Preferably, the unsaturated olefin compound may be present in amounts of about 40% to about 80% by weight of the total resin composition. More preferably, the unsaturated compound may be present in amounts of about 60% to about 70% of the total resin composition.

The unsaturated olefin compound is the “comb” monomer used to form the side chain(s) of the comb-like network structure of the silicone-hybrid resin.

The compound comprising at least one silicone hydride functional group is used to form the backbone of the silicone-hybrid resin.

The compound comprising at least one silicon hydride functional group (“silicon hydride functional compound”) which is useful for preparing the silicone-hybrid resin includes, for example, a hydrido-functional polydimethylsiloxane. It is useful when the silicon hydride functional compound comprises silicon hydride functional groups at terminal ends thereof. For example, it is useful when the silicon hydride functional compound comprises at least two silicon hydride functional groups. A particularly useful silicon hydride functional compound is a siloxane. For example, the silicon hydride functional compound may be a siloxane having a backbone comprising at least two silicon hydride functional groups attached to the backbone. The silicon hydride functional compound may be polydimethylsiloxane (PDMS). It is particularly useful when the silicon hydride functional compound is methylhydridosiloxane-dimethylsiloxane copolymer.

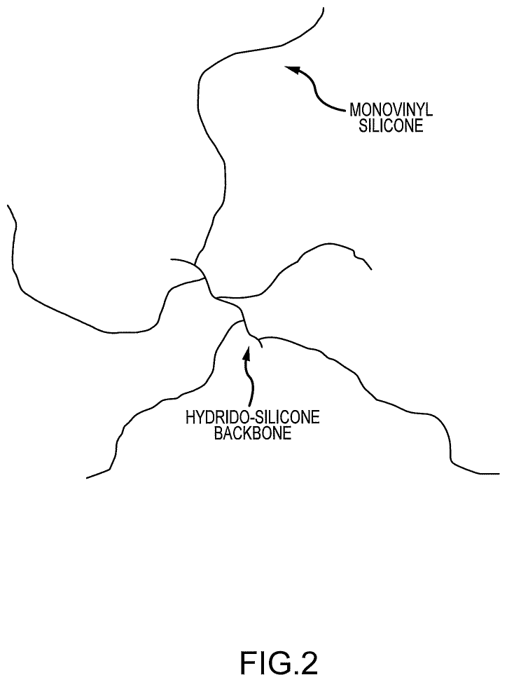

Desirably, a composition of the invention includes a PDMS that has pendent hydrido functional groups along the PDMS backbone. This allows for the uPAO molecules and the crosslinker to react via hydrosilation to form the hybrid resin. A PDMS with terminal hydridofunctionality would not be nearly as effective or reactive as a pendent PDMS. A comb structure created by grafting a compound comprising one unsaturated olefin having vinyl functionality located at the terminal end(s) or pendent on the compound (mono-vinyl polydimethylsiloxane (PDMS)) to a compound comprising at least one silicon hydride functional group (methylhydridosiloxane-dimethylsiloxane copolymer) is shown in FIG. 2. The silicon hydride functional compound may have an average molecular weight from at least about 100 up to at least about 20,000. For example, the silicone hydride functional compound may have an average molecular weight of greater than about 1000. It is useful when the silicon hydride functional compound has an average molecular weight of greater than about 3000. It is particularly useful when the average molecular weight of the silicone hydride functional compounds is from about 6000 to about 12,000.

The silicon hydride functional compound may have a viscosity of about 500 cps or less. Viscosities are measured with a Brookfield CAP 2000+ viscometer at room temperature. In particular, viscosities are measured at 25° C. using a Brookfield cone and plate viscometer.

The silicon hydride functional compound may be present in amounts of about 1% to about 80% by weight of the total resin composition. Preferably, the silicon hydride functional compound may be present in amounts of about 40% to about 60% by weight of the total resin composition. More preferably, the silicon hydride functional compound may be present in amounts of about 30% to about 50% by weight of the total resin composition.

The curable compositions including the unsaturated olefin compound and the silicon hydride functional compound also include a crosslinker including at least two vinyl or vinylidene or vinylene groups.

It will be understood that where a crosslinker component including at least two vinyl functional groups is disclosed for use in the compositions and methods disclosed herein, a vinylene compound with one or multiple internal double bonds —CH═CH— may be used instead as the crosslinker component. Accordingly, a vinylene compound with one of more multiple internal bonds double bonds —CH═CH— may be used as the crosslinker component with the SiH compound instead of using the crosslinker component including at least two vinyl functional groups with the SiH compound. The molecular weight of the vinylene compound including one of more multiple internal double bonds —CH═CH— may have an average molecular weight of at least about 100 up to about 10,000. An example of a vinylene compound comprising one internal double bond —CH═CH— for use as a crosslinker component in the compositions, systems, methods and reactions disclosed herein (in lieu of the crosslinker component including at least two vinyl functional groups) is methyl oleate (MW 296), which is a renewable resource. An example of a compound having multiple internal double bonds for use as a crosslinker component in the compositions, systems, methods and reactions disclosed herein (in lieu of the crosslinker component including at least two vinyl functional groups) is high oleic soybean oil (MW of about 880), which is a polyunsaturated triglyceride and also a renewable resource. Accordingly, instead of a crosslinker component including at least two vinyl functional groups, the crosslinker component may be a vinylene compound including one or multiple internal double bonds-CH═CH— which is a renewable resource, such as high oleic soybean oil (MW of about 880).

The crosslinker component may be present in amounts of about 1% to about 20% by weight of the total composition. Preferably, the crosslinker component may be present in amounts of about 2% to about 10% by weight of the total composition. More preferably, the crosslinker component may be present in amounts of about 3% to about 7% by weight of the total composition.

The balance between the components can be adjusted to change the hardness of the composition. Styrene is particularly useful co-monomer for adjusting hardness and mechanical properties. The effectiveness of the thermal interface material to transfer heat is significantly impacted by the interface between the TIM and the heat source and a soft, conformable material can optimize the contact at the interface.

The ratio of the unsaturated olefin compound to the silicon hydride functional compound may be selected to optimize the hardness of the composition. Preferably, the ratio of unsaturated olefin compound to the silicon hydride functional compound ranges from about 0.5:1 to about 2:1 where the ratio is molar by functionality. More preferably, the ratio of the unsaturated olefin compound to the silicon hydride functional compound ranges from about 0.8:1 to about 1.2:1 where the ratio is molar by functionality.

The vinyl:SiH reactive group ratio may be in the range of about 0.5:1 to 2:1. More particularly, the vinyl:SiH reactive group ratio may be in the range of about 0.8:1 to 1.2:1.

The Shore OO Hardness, measured at 24 hours at 22-25° C. of the silicone-hybrid resin may be: less than about 90; less than about 80; or from about 1 to about 90. The resin is a soft, conformable material that can optimize the contact at the interface, which it is placed onto. A silicone resin matrix may be used in a thermally conductive composition as described herein. The silicone resin of the silicone resin matrix may be any silicone resin known in the art, including DMS-V21, which is a divinyl terminated silicone supplied by Gelest, and Polymer VS 50, which is vinyl-terminated polydimethylsiloxane (PDMS) available from Evonik Industries. Any vinyl functional silicone is useful, including ones that have pendant vinyl groups. Suitable vinyl functional silicones include those available, for example, from suppliers such as Gelest, Evonik, AB Specialty Silicones, Nusil, Wacker, Shin Etsu, Dow Corning.

DMS-V21, which is available from Gelest, has a molecular weight (MW) of 6,000 g/mol, a density at 25° C. of 0.97 a wt. % vinyl of 0.8-1.2, vinyl (eq/kg) of 0.33-0.37 and a viscosity of 100 cSt. The silicone or silicone-hybrid resin matrix may be included in a thermally conductive composition described herein in an amount from about 5% by weight to about 50% by weight of the thermally conductive composition depending upon thermal conductivity requirements.

A thermally conductive composition as described herein includes a conductive filler. The conductive filler may be both thermally conductive and electrically conductive. Alternatively, the thermally conductive filler may be thermally conductive and electrically insulating.

Preferably, the conductive filler is a conductive filler including an aluminum oxide-containing particle. A particularly useful filler including an aluminum oxide-containing particle is Aluminum Trihydroxide (ATH). A useful conductive filler including an aluminum oxide-containing particle includes aluminum trihydroxide, with or without alumina. For example, a useful conductive filler including an aluminum oxide-containing particle includes aluminum trihydroxide and alumina. Any suitable ATH can be used in a thermally conductive composition as described herein including, for example, 10 micron ground ATH, 4 micron ground ATH and 45 micron ground ATH. Suppliers of ATH suitable for use in the thermally conductive composition described herein include, for example, RJ Marshall, Huber Engineered Materials (Atlanta, Ga.). Sibelco North America, Inc. (Charlotte, N.C.), Aluchem (Cincinati, Ohio). Other suppliers of ATH suitable for use in the thermally conductive composition described herein can be found at, for example, https://polymer-additives.specialchem.com/selectors/c-additives-flame-retardants-smoke-suppressants-aluminum-trihydroxides-ath.

Desirably, the ATH is Aluminum Trihydrate sold under the tradename Maxfil® and supplied by RJ Marshall. For example, MX100 ATH, MX104 ATH and MX200 ATH, which are all supplied by RJ Marshall, can all be used in the compositions of the present invention. Most desirably, the ATH is MX200 ATH, supplied by RJ Marshall. A filler for a thermally conductive composition herein can be an ATH blend optimized for low viscosity.

The conductive filler including an aluminum oxide-containing particle may include aluminum trihydroxide and alumina in a mixture by weight ratio of about 95:5 to about 5:95.

The weight ratio of the conductive filler to resin matrix may be present in an amount from about 95:5 to about 5:95.

The conductive filler may comprise aluminum particles having aluminum oxide layers on their surfaces. The conductive filler may be an alumina blend, such as an alumina blend having aluminum-oxide containing spherical particles.

The shape of useful thermally conductive filler particles is not restricted; however, rounded or spherical particles may prevent viscosity increase to an undesirable level upon high loading of thermally conductive filler in the composition.

Other suitable fillers and/or additives may also be added to the compositions disclosed herein to achieve various composition properties. Examples of additional components that may optionally be added include pigments, plasticizers, process aids, flame retardants, extenders, electromagnetic interference (EMI) or microwave absorbers, electrically conductive fillers, magnetic particles, etc. A wide range of materials may be added to a TIM according to exemplary embodiments, such as carbonyl iron, iron silicide, iron particles, iron-chrome compounds, metallic silver, carbonyl iron powder, SENDUST (an alloy containing 85% iron, 9.5% silicon and 5.5% aluminum), permalloy (an alloy containing about 20% iron and 80% nickel), ferrites, magnetic alloys, magnetic powders, magnetic flakes, magnetic particles, nickel-based alloys and powders, chrome alloys, and any combinations thereof. Other embodiments may include one or more EMI absorbers formed from one or more of the above materials where the EMI absorbers comprise one or more of granules, spheroids, microspheres, ellipsoids, irregular spheroids, strands, flakes, powder, and/or a combination of any or all of these shapes. Accordingly, some exemplary embodiments may thus include TIMs that include or are based on thermally reversible gels, where the TIMs are also configured (e.g., include or are loaded with EMI or microwave absorbers, electrically conductive fillers, and/or magnetic particles, etc.) to provide shielding.

In a useful embodiment, when a composition as described herein is a two-part composition, thermally conductive filler material is present in the first part of the composition in an amount in the range of about 30-95 wt. %, for example from about 85-95 wt. % based on the total weight of the first part. In another useful embodiment, the thermally conductive filler material is present in the second part in an amount in the range of about 30 wt. % to about 95 wt. %, for example in an amount from about 85 wt. % to about 95 wt. % based on the total weight of the second part. In yet another useful embodiment, the thermally conductive filler material is present both in the first and the second parts in an amount of about 30 wt. % to about 95 wt. %, and the total weight, based on both parts, of the thermally conductive filler material is present in an amount of about 30 wt. % to about 95 wt. %, preferably from about 85-95 wt. %.

It is particularly useful when the conductive filler is present in a thermally conductive one-part composition as described herein in an amount of from about 50 to about 95 weight percent. Most preferably, the conductive filler is present in a thermally conductive one-part composition as described herein in an amount of from about 70 to about 90 weight percent. For example, when the thermally conductive composition is a one-part composition, it is preferable that the conductive filler is present in an amount from about 50 to about 95 wt % and, more preferably, in an amount from about 70 to 90 wt. %.

Desirably, compositions as described herein include thermally conductive filler in two part compositions. For example, two-part compositions are used when a hydridofunctional PDMS and the catalyst have to be loaded separately. A composition as described herein can be a one-part composition when a catalyst that is heat activated is used.

A composition or system as described herein which includes one or more fillers is referred to as filled. A composition or system as described herein which does not include one or more fillers is referred to as unfilled.

A thermally conductive composition as described herein includes a liquid organic acid which is soluble in the silicone or silicone-hybrid resin matrix. The liquid organic acid is a diluent. The liquid organic acid may be a carboxylic acid, including a fluorinated carboxylic acid. The liquid organic acid also may be a phosphorous-containing acid or a sulfur-containing acid. Branched olefin acids such as Iso-stearic Acid-N (ISAN) and similar acid additives are useful. Acid additives include, for example, simple alkyl acids. It is useful when the liquid organic acid is selected from Iso-stearic Acid N, BYK 9076, BYK-W 969, Disperbyk 2008, Disperbyk 108, Disperbyk 2152, Disperbyk 118 and Disperbyk 168. BYK-W 969, BYK 9076, Disperbyk 2008, Disperbyk 108, Disperbyk 2152, Disperbyk 118 and Disperbyk 168 are available from BYK and are wetting/dispersing agents. When Disperbyk 108 is used in a thermally conductive composition as described herein, a gel (Shore OO of 0) can result. It is also useful when the liquid organic acid is selected from Isostearic Acid-N, 2-hexyl decanoic acid, 2-butyl octanoic acid, cyclopentane octanoic acid, 4-dodecyl sulfonic acid, perfluoro heptanoic acid, nonafluoro butane-1-sulfonic acid, bis(2,4,4-)trimethylpentylphosphinic acid and combinations thereof.

Desirably, the liquid organic acid is present in an amount of from about 0.01 to about 5 weight percent based on the total combined formulation. The liquid organic acid may be present in an amount of from about 0.5 to about 2.0 weight percent based on the total combined formulation.

Eutectic acid mixtures can be used in a thermally conductive composition as described herein provided that the eutectic point is lower than ambient temperature of around 20° C. As used herein, the term “eutectic mixture” refers to a mixture of two or more substances which melts at the lowest freezing point of any mixture of the components. This temperature is the eutectic point.

The eutectic acid mixture liquid organic acid may be present in an amount of from about 0.01 to about 5 weight percent based on the total combined formulation. Desirably, the eutectic acid mixture is present in an amount of from about 0.5 to about 2.0 weight percent based on the total combined formulation.

A thermally conductive composition as described herein has an acceptable viscosity at room temperature. Room temperature includes, for example, a temperature of about 25° C. Typically, a thermally conductive composition as described herein has a viscosity from about 5,000 cps to about 15,000 cps at room temperature. It is useful when a thermally conductive composition as described herein has a viscosity of less than about 12,000 cps at room temperature. For example, a thermally conductive composition as described herein may have a viscosity from about 8,000 cps to about 10,000 cps at room temperature. Optimally, a thermally conductive composition as described herein has a viscosity of about 10,000 cps at room temperature. Desirably, a thermally conductive composition as described herein has a viscosity of less than about 10,000 cps at room temperature. More desirably, a thermally conductive composition as described herein has a viscosity of less than about 9,000 cps at room temperature. A thermally conductive composition as described herein may comprise from about 80-90 wt. % of ATH and from about 10-20 wt. % resin and may have an acceptable viscosity at room temperature. Desirably, a thermally conductive composition as described herein may comprise from about 80-90 wt. % of ATH and from about 10-20 wt. % resin and has a viscosity of about 10,000 cps. As used herein, the viscosity is for the whole composite composition, including fillers. In fully formulated compositions of the invention, more ATH can be loaded to maximize thermal conductivity.

By including a liquid organic acid as described herein in a thermally conductive composition as described herein, the liquid organic acid will (1) decrease the viscosity of the thermally conductive composition to an acceptable level and (2) not inhibit the curing profile of the formulated resin. Branched olefin acids such as Iso-stearic Acid-N and similar acid additives will (1) decrease the viscosity of the thermally conductive composition to an acceptable level and (2) not inhibit the curing profile of the formulated resin. Ensuring that the diluent does not inhibit the curing profile of the formulated resin is vitally important. Many commercial dispersing agents supplied by BYK, such as those discussed above, can reduce the viscosity to an acceptable level. Simple alkyl acids can be even more effective and have less of an impact on hydrosilyation cure.

A thermally conductive composition as described herein may have thermal conductivity of up to about 10 W/m·k. Desirably, a thermally conductive composition as described herein may have thermal conductivity of up to about 3 W/m·k. More desirably, a thermally conductive composition as described herein may have a thermal conductivity of from about 1.0 W/m·k to about 2 W/m·k or higher. For example, the thermally conductive composition may have a thermal conductivity of about 1.5 W/m·k, which is useful for applications such as lighting and automotive electronics. The thermally conductive composition may have a thermal conductivity of about 3-4 W/m·k, which is useful for higher end applications such as harddisk, electrical vehicles. In some cases, the thermally conductive composition may have a thermal conductivity of about 10 W/m·k, which is useful for 5G telecommunication applications.

When pure aluminum trihydroxide (AL(OH)₃) is used as the conductive filler, a thermally conductive composition as described herein may have a thermal conductivity of from about 1 W/m·k to about 2 W/m·k, depending on the loading of the fillers. When 90:10 alumina powder:hybrid Si-PAO resin is used, a thermally conductive composition as described herein may have a thermal conductivity of about 3.6 W/m·k. When a 85:15 ATH:hybrid Si-PAO resin is used, a thermally conductive composition as described herein may have a thermal conductivity of about 1.5 W/m·k. Since the thermal conductivity of pure alumina fillers typically ranges from 20-30 W/m·k, they may boost the thermal conductivity of ATH-filled systems if used properly. In addition, silane treatment is frequently used to modify the surface of aluminum oxide or aluminum trihydroxide for rheology modification. With these acid additives, the extra treatment step could potentially be eliminated.

One or several catalysts can be included in the compositions disclosed herein to tune the curing speed depending on the application and process requirements. For example, the curable compositions including the unsaturated olefin compound and the silicon hydride functional compound also may include a catalyst. In the two-part composition disclosed herein for making a silicone-hybrid resin, the unsaturated olefin compound and the silicon hydride functional compound are each dispensed and then mixed to be reacted. If the catalyzed reaction is too fast, the reactants may clog the dispensing mechanism. If the catalyzed reaction is too slow, the composite may flow out of the area where it is intended to be set after application and contaminate other surrounding components. Accordingly, the reaction speed is critical to obtain the desired properties of the composition. Suitable catalysts include hydrosilation catalysts. The hydrosilation catalyst may be selected from metallocene compounds. The hydrosilation catalyst may be a platinum catalyst. A particularly useful catalyst for use in the composition is a Karstedt Catalyst, which is supplied by Gelest. Karstedt Catalyst is platinum-divinyltetramethyldisiloxane complex, which is typically supplied as a 2% Pt solution in xylene or divinyl polydimethylsiloxane. Such a catalyst includes less than 10 Pt complex and greater than 90 Xylenes. SIP6831.2 (platinum divinyltetramethyldisiloxane), available from Gelest, is a useful hydrosilation catalyst.

Metal complexes such as [RhCl(PPh₃)₃] (Wilkinson's catalyst), RuCl₂(CO)₂(PPh₃)₂, [Cp*Ru(MeCN)₃]PF₆ (Cp*=pentamethylcyclopentadienyl), H₂PtCl₆ (Speier's catalyst) as well as noble metal particles such as nano platinum have also been used as Hydrosilation catalysts. More recently, other catalysts have been found useful, as described in a recent publication in Polymers, 2017, 9(10): 534 titled “Fifty Years of Hydrosilylation in Polymer Science: A Review of Current Trends of Low-Cost Transition-Metal and Metal-Free Catalysts, Non-Thermally Triggered Hydrosilylation Reactions, and Industrial Applications”. These include low-cost transition metal catalysts such as iron, cobalt, and nickel complexes, metal-free catalysts. Additional developments are discussed in Nature Reviews Chemistry, volume 2, pages 15-34(2018) titled “Earth-abundant transition metal catalysts for alkene hydrosilylation and hydroboration”, as well as in RSC Adv., 2015, 5, 20603-20616 titled “Hydrosilylation reaction of olefins: recent advances and perspectives”. For one-part compositions, volatile inhibitors might be added to the catalyst system. Upon exposure to air, these inhibitors will evaporate to allow the reaction to proceed. Alternatively, a UV generated platinum catalyst might be used to trigger reaction.

A thermally conductive composition as described herein including (a) a silicone or silicone-hybrid resin matrix, (b) a conductive filler including an aluminum oxide-containing particle; and (c) a liquid organic acid soluble in the matrix may include a catalyst, such as a hydrosilation catalyst. The catalyst may be a catalyst, including a hydrosilation catalyst, as described above.

A thermally conductive composition as described herein including (a) a silicone or silicone-hybrid resin matrix, (b) a conductive filler including an aluminum oxide-containing particle; and (c) a liquid organic acid soluble in the matrix may further include a crosslinker such as a crosslinker component described above.

A thermally conductive composition as described herein including (a) a silicone or silicone-hybrid resin matrix, (b) a conductive filler including an aluminum oxide-containing particle; and (c) a liquid organic acid soluble in the matrix may further include a catalyst, such as a hydrosilation catalyst, and a crosslinker. The catalyst may be a catalyst, including a hydrosilation catalyst, as described above. The crosslinker may be a crosslinker component as described above.

The curable compositions may include wetting and dispersing additives, defoamers and air release agents, surface modifiers and rheology modifiers. Many of these products are available from BYK (BYK-Chemie GmbH, Germany). Further optional components can be added to the composition, such as for example, nucleating agents, elastomers, colorant, pigments, rheology modifiers, dyestuffs, mold release agents, adhesion promoters, flame retardants, a defoamer, a phase change material, rheology modifier processing aids such as thixotropic agents and internal lubricants, antistatic agents or a mixture thereof which are known to the person skilled in the art and can be selected from a great number of commercially available products as a function of the desired properties. The amounts of these additives incorporated into the composition can vary depending on the purpose of including the additive. Other additives known in the art also may be included in the curable compositions described herein.

The composition may optionally further comprise up to about 80 wt. %, by weight of the composition of a liquid plasticizer in the first and/or second part. Suitable plasticizers include paraffinic oil, naphthenic oil, aromatic oil, long chain partial ether ester, alkyl monoesters, epoxidized oils, dialkyl diesters, aromatic diesters, alkyl ether monoester, polybutenes, phthalates, benzoates, adipic esters, acrylate and the like.

In one embodiment, the curable composition further comprises a moisture scavenger. Preferably the moisture scavenger is selected from the group comprising oxazolidine, p-toluenesulfonyl isocyanate, vinyloxy silane, and combinations thereof. p-Toluenesulfonyl isocyanate is a particularly useful moisture scavenger.

The compositions disclosed herein may further optionally comprise up to about 3.0 wt. %, for example about 0.1 wt. % to about 2.5 wt. %, and preferably about 0.2 wt. % to about 2.0 wt. %, by weight of the resin composition in each part, of one or more of an antioxidant or stabilizers.

Useful stabilizers or antioxidants include, but are not limited to, high molecular weight hindered phenols and multifunctional phenols such as sulphur and phosphorus-containing phenols. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency, and correspondingly, its reactivity; this hindrance thus provides the phenolic compound with its stabilizing properties. Representative hindered phenols include: 1,3,5-trimethyl-2,4,6-tris-(3,5-di-tert-butyl-4-hydroxybenzyl)-benzene, pentaerythrityl tetrakis-3(3,5-di-tert-butyl-4-hydroxyphenyl)-propionate; n-octadecyl-3(3,5-ditert-butyl hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; hexadecyl 3,5-di-tert-butyl-4-hydroxybenzoate; and sorbitol hexa[3-(3,5-ditert-butyl-4-hydroxy-phenyl)-propionate].

Useful antioxidants are commercially available from BASF Corporation and include Irganox®565, 1010, 1076 and 1726 which are hindered phenols. These are primary antioxidants that act as radical scavengers and may be used alone or in combination with other antioxidants, such as, phosphite antioxidants like IRGAFOS 168 available from BASF.

The inclusion of antioxidants and/or stabilizers in the compositions disclosed herein should not affect other properties of the composition.

One or more retarding agents can also be included in the composition to provide an induction period between the mixing of the two parts of the composite composition and the initiation of the cure. Preferably, the retarding agent can be 8-hydroxyquinoline.

It is desirable to have some latency in the first 30-60 min of the reaction, and the catalyst with inhibitor/retarder combination may be chosen to dial-in this efficacy. This is particularly useful for two-part gap filler applications, to allow positioning of the parts, and fully cure within 48 hours, and preferably within 24 hours. This allows time to rework the material to reposition the material without damaging expensive component substrates.

The composition according to this invention may be used as a TIM to ensure consistent performance and long-term reliability of heat generating electronic devices. Specifically, these compositions can be used as a liquid gap filler material that can conform to intricate topographies, including multi-level surfaces. Due to the increased mobility prior to cure, the composition can fill small air voids, crevices, and holes, reducing overall thermal resistance to the heat generating device. Additionally, thermal interface gap pads can be prepared from this composition. A gap filler is a liquid paste. A gap pad is a solid pad.

Manual or semiautomatic dispensing tools can be used to apply the composition directly to the target surface, resulting in effective use of material with minimal waste. Further maximization of material usage can be achieved with implementation of automated dispensing equipment, which allows for precise material placement and reduces the application time of the material. Accordingly, the viscosity of each part of the composition must be maintained such that the parts can be dispensed through the dispensing tools. Each of the first part and the second part has a viscosity of less than about 1500 Pa·s at room temperature, preferably less than about 1000 Pa·s, and more preferably less than about 500 Pa·s. For a filled composition (resin plus filler) to be dispensable, the viscosity, at 1/sec shear rate, is less than about 1500 Pa·s, preferably less than about 1000 Pa·s, and more preferably less than about 500 Pa·s. The viscosity may be measured by ASTM D2196 using a parallel plate rheometer, particularly the test is conducted on a TA Instruments HR-3 Discovery rheometer with 25 mm parallel plates. For example, a viscosity of from about 300 to about 500 Pa·s provides suitable stability. The shear rate is ramped from 0.3/second to 5/sec and viscosity value is recorded at 1/sec.

Typically, dispensing the material from a cartridge can take up to several hours. It is desirable to have a speed of at least 20 g/min for initial dispensing since this ensures high throughput when the material is applied to an actual device. In addition, 30 to 60 min latency ensures that the mixing area does not get clogged during a temporary production pause.

A high dispensing rate is an advantage of the compositions and systems of the invention including a PAO. In particular, a high dispensing/extrusion rate out of a typical EFD syringe is an advantage of the compositions and systems including a PAO. For example, the dispensing rate out of, for example, a typical EFD syringe, for a single component (either Part A or Part B in a two component system) composition is greater than 30 mL/minute, preferably greater than 60 mL/minute and more preferably greater than 100 cc/minute. Such a test is conducted with material filled in a 30 mL Nordson EFD syringe with a 0.1″ orifice which is then dispensed at 75-90 psi for a given time (a few seconds to 1 minute).

Desirably, a thermally conductive composition as described herein desirably has a dispensing rate of from about 200 to about 2000 g/min at 75 psi.

Besides adhering to the molar ratios of the vinyl and silicon hydride functionalities in the mixture when a silicone-hybrid resin is used, it is desirable to dispense the same or substantially the same volume of both parts, A and B, to combine them in the mixing area. Generally, both parts have similar densities, but the weights can be adjusted based on the densities of each part to provide the same volume. Other volume mixing ratios may also be used, such as 1:2, 1:4, 1:10.

Desirably, a thermally conductive composition as described herein is in a flowable form.

Where a composition as described herein includes a first part and a second part, the first part and second part of the composition can be mixed to form a composition that can be cured at room temperature. The mixed composition has a pot life of longer than about 10 minutes, and preferably longer than about 20 min. It is desirable to have some latency in the first 30-60 minutes after mixing to allow positioning of the parts, and full cure within 48 h, preferably 24 hours.

The composition, after room temperature cure, has a glass transition temperature (Tg) of less than about −20° C., preferably less than about −30° C. Further, the cured composition is thermally stable from about −40° C. to about 125° C.

The Shore OO Hardness, measured at 24 hours at room temperature, i.e., about 22-25° C., of an unfilled composition (resin without filler) may be from 0 to about 90, from about 0 to about 30 or from about 0 to about 20. The Shore OO hardness, measured at 24 hours at room temperature, i.e., about 22-25° C., for a filled composition (resin plus filler) is less than about 90 or less than about 80. The Shore OO hardness test is at room temperature using a Shore OO Scale Ergo Durometer 411 according to ASTM D2240 by PTC Instruments (Los Angeles, Calif.) or a Type 00, Model 1600 durometer from Paul N. Garnder Company, Inc. (Pompano Beach, Fla.). The resin is a soft, conformable material that can optimize the contact at the interface, which it is placed onto.

A stable modulus at elevated temperatures indicate the resin as thermally stable, and the resin can maintain the shape as a TIM in use. Also, the gradual drop of the Tg, instead of sharp decline in G′, denotes heat stability of the cured resin. These characteristics of the resin ensure good dampening performance of the resin to minimize mechanical shock to its attached substrates. In one embodiment, the resin may be formed as a component in an electronic device, e.g., battery, and thus, Shore OO Hardness less than about 90 is desirable since this allows for good damping performance to absorb shocks and minimizes damage in the material, rather than transferring that shock onto expensive battery components. In a preferred embodiment, Shore OO Hardness change of less than 50, usually less than 20 is desirable under aggressive aging conditions, e.g., 100° C./2 hours.

In some exemplary embodiments, a TIM may include an adhesive layer. The adhesive layer may be a thermally conductive adhesive to preserve the overall thermal conductivity. The adhesive layer may be used to affix the TIM to an electronic component, heat sink, EMI shield, etc. The adhesive layer may be formulated using a pressure-sensitive, thermally conducting adhesive. The pressure-sensitive adhesive (PSA) may be generally based on compounds including acrylic, silicone, rubber, and combinations thereof. The thermal conductivity is enhanced, for example, by the inclusion of ceramic powder as ceramics are generally more conductive.

In some exemplary embodiments, TIMs including thermally-reversible gel may be attached or affixed (e.g., adhesively bonded, etc.) to one or more portions of an EMI shield, such as to a single piece EMI shield and/or to a cover, lid, frame, or other portion of a multi-piece shield, to a discrete EMI shielding wall, etc. Alternative affixing methods can also be used such as, for example, mechanical fasteners. In some embodiments, a TIM that includes thermally-reversible gel may be attached to a removable lid or cover of a multi-piece EMI shield. A TIM that includes thermally-reversible gel may be placed, for example, on the inner surface of the cover or lid such that the TIM will be compressively sandwiched between the EMI shield and an electronic component over which the EMI shield is placed. Alternatively, a TIM that includes thermally-reversible gel may be placed, for example, on the outer surface of the cover or lid such that the EMI shield is compressively sandwiched between the EMI shield and a heat sink. A TIM that includes thermally-reversible gel may be placed on an entire surface of the cover or lid or on less than an entire surface. A TIM that includes thermally-reversible gel may be applied at virtually any location at which it would be desirable to have an EMI absorber.

Further contemplated herein is a device comprising a heat-source, a heat sink, and the compositions disclosed herein disposed therebetween. In a preferred embodiment, the device does not leave an air gap between the heat source and the heat sink.

Also provided is a curable composition of the present invention made with no PAO or comb polymer.

### EXAMPLES

The base resin used in the examples is a hybrid PAO-silicone resin as described herein. The unsaturated mPAO dimer referred to as F-1-A is an unsaturated metallocene derived α-olefin dimer, obtained from ExxonMobil. The ATH used in all examples is MX200 supplied by RJ Marshall. The ISAN used in all examples is Iso-stearic Acid N supplied by Nissan Chemical America Corporation. Miramer M201, 1,6-hexanediol diacrylate (HDDMA) was obtained from Miwon Specialty Chemical Co., Ltd. Crosslinker 100, a hydridosilicone resin, was obtained from Evonik. Dispersing agents were obtained from BYK. In the Tables in the Examples, Mw is average molecular weight and EW is equivalent weight based on reactive functionalities. RT is room temperature.

### Example 1—Screen of Dispersants

A screen of various dispersants with an 80:20 mix of MX200:Part A was conducted. In order to screen various dispersants in an 80:20 mix of MX200:Part A, catalyst was not included (although listed as a reagent in Table 1) since it would not have had much of an effect on the viscosity of the formulation.

The procedure for the study was as follows:

0) Make Part A (as per Table 1). The Part A resin had a ratio of unsaturated mPAO dimer (F-1-a):HDDMA of 7.37:0.37.
1) Add Part A and MX200 and speedmix at 1000 RPM for 1 min in a FlackTek speedmixer. Measure baseline viscosity.
2) Add dispersant for 0.5%, 1% and 2% dispersant (as per Table 2) to form Inventive Compositions #1-24. Speedmix at 1000 RPM for 1 min. Measure viscosity of each of the 24 formulations (at 25° C. at 10 RPM and at 20 RPM). The dispersants which were added are set forth in Table 3.

TABLE 1

| | PAO-SiH | | |
|---|---|---|---|
| | hybrid resin | | |
| Reagent | #1 | Part A | Part B |
| Unsaturated mPAO | 10.14 | 7.37 | 2.77 |
| dimer¹ | | | |
| Crosslinker 100 (g) | 5.00 | | 5.00 |
| M201 1,6-HDDMA (g) | 0.37 | 0.37 | |
| SIP6831.2 (g) | 0.03 | | |
| mol % M201 | 7.50 | 7.74 | 7.77 |

¹F-1-a

TABLE 2

| | | 1.0% | |
|---|---|---|---|
| Reagent | 0.5% Dispersant | Dispersant | 2.0% Dispersant |
| MX 200 (g) | 10.0 | 10.0 | 10.0 |
| Part A (g) | 2.50 | 2.50 | 2.50 |
| Dispersant (g) | 0.06 | 0.13 | 0.26 |

TABLE 3
Viscosities (cps) @ 25° C. of Inventive Compositions # 1-24

| | | 10 RPM | | | 20 RPM | | |
|---|---|---|---|---|---|---|---|
| Dispersant | Descriptions | 0.50% | 1.00% | 2.00% | 0.50% | 1.00% | 2.00% |
| Iso-Stearic | Branched C18 acid | #1 | #2 | #3 | #1 | #2 | #3 |
| Acid N | | 9640 | 10700 | 9780 | 4180 | 4100 | 3790 |
| BYK-W 969 | 40% solution of a hydroxy- | #4 | #5 | #6 | #4 | #5 | #6 |
| | functional alkylammonium | 9410 | 11030 | 9110 | 4820 | 6620 | 4650 |
| | salt of an acidic copolymer | | | | | | |
| BYK 9076 | Alkylammonium salt of a | #7 | #8 | #9 | #7 | #8 | #9 |
| | high molecular-weight | 13650 | 9860 | 8930 | 6090 | 4370 | 4180 |
| Disperbyk 2008 | PPG Solution of a structured | #10 | #11 | #12 | #10 | #11 | #12 |
| | acrylate copolymer with | 19000 | 15560 | 11550 | 7070 | 6220 | 6000 |
| | pigment-affinic groups | | | | | | |
| Disperbyk 108 | Hydroxy-functional | #13 | #14 | #15 | #13 | #14 | #15 |
| | carboxylic acid ester with | 16350 | 10730 | 9790 | 3580 | 3840 | 2930 |
| | pigment-affinic groups | | | | | | |
| Disperbyk 2152 | Hyperbranched polyester | #16 | #17 | #18 | #16 | #17 | #18 |
| | | 18640 | 11960 | 12750 | 7540 | 6640 | 6960 |
| Disperbyk 118 | Linear polymer with highly | #19 | #20 | #21 | #19 | #20 | #21 |
| | polar, different pigment- | 15600 | 10950 | 10650 | 6320 | 6260 | 5570 |
| | affinic groups (80% in | | | | | | |
| | methoxypropylacetate) | | | | | | |
| Disperbyk 168 | Dicarboxylic acid ester | #22 | #23 | #24 | #22 | #23 | #24 |
| | solution of a high molecular | 24260 | 15000 | 14250 | 11380 | 6450 | 6500 |
| | weight block copolymer with | | | | | | |
| | pigment affinic groups | | | | | | |

The baseline viscosity of the 80:20 mix of MX200: Part A was 238,000 cps at RT, i.e., at 25° C. The viscosity of each 80:20 mix of MX200: Part A after dispersant was added is set forth in Table 3. As is apparent from Table 3, all of the dispersants reduced the viscosity by about an order of magnitude. From the dispersants listed in Table 3, Iso-stearic Acid N, BYK-W 969 and Disperbyk 108 were selected for further study as set forth in Example 2.

### Example 2—Impact of Dispersants on Resin Curing

A study was conducted to explore the effects of adding various dispersants to a base resin system where the resin is a silicone-hybrid resin. Compositions were prepared in accordance with Table 4. IC #25 and #26 are inventive compositions. CC #1 and #2 are comparative compositions.

TABLE 4

| Reagent | IC #25 | CC #1 | IC #26 | CC #2 |
|---|---|---|---|---|
| Unsaturated mPAO dimer¹ (g) | 10.14 | 10.14 | 10.14 | 10.14 |
| Crosslinker 100 (g) | 5.00 | 5.00 | 5.00 | 5.00 |
| M201 1,6-HDDMA (g) | 0.37 | 0.37 | 0.37 | 0.37 |
| Iso-stearic Acid N (g) | 0.19 | | | |
| (Dispersant 1) | | | | |
| BYK-W 969 (g) | | 0.19 | | |
| (Dispersant 2) | | | | |
| Disperbyk 108 (g) | | | 0.19 | |
| (Dispersant 3) | | | | |
| Tetradecylphosphoric acid (g) | | | | 0.19 |
| (Dispersant 4) | | | | |
| SIP6831.2 (g) | 0.03 | 0.03 | 0.03 | 0.03 |
| Weight % Dispersant | 1 | 1 | 1 | 1 |

¹F-1-a

Dispersants 1 and 3 went into solution after mixing for 1 min/1000 RPM. Dispersants 2 and 4, however, did not. Dispersants 2 and 4 were additionally mixed twice for 1 min/2000 RPM. CC #1 was still hazy with some tiny yellow droplets of Dispersant 2 at the bottom. CC #2 still had flakes of Dispersant 4 after additional mixing. CC #2 and CC #4 were then heated at 40° C. for 1 hour to help get the dispersants into solution.

The Shore hardness OO of each of IC #25, CC #1, IC #26 and CC #2 was measured. The results are set forth in Table 5.

TABLE 5

| | | | Shore OO |
|---|---|---|---|
| | | Shore OO | (48 hr + |
| Sample | Dispersant | (24 hr) | 1 hr 80° C.) |
| IC #25 | 1% ISAN | 0 | 0 |
| CC #1 | 1% BYK-W969 | Immiscible | — |
| IC #26 | 1% Disperbyk 108 | Homogeneous Liquid | 0 |
| CC #2 | 1% Tetradecyl | Immiscible | — |
| | Phosphoric acid | | |

As is apparent from Table 5, ISAN has the least impact on cure. The BYK-W969 and Disperbyk 108 additives may improve rheology, but seemed to affect hydrosilation cure. Where the compositions are immiscible, they cannot be used with resin PAO or other hydrosilation resins.

### Example 3—ATH Filler Study for Thermal Conductivity with 7.5% Crosslinker

Thermal conductivity was measured of an Inventive Composition #27 (IC #27) formulated with an ATH at 85:15 with PAO-silicone hybrid resin and 7.5% HDDMA crosslinker.

TABLE 6

| | PAO-SiH | | |
|---|---|---|---|
| | hybrid | | |
| Reagent | resin #2 | Part A | Part B |
| unsaturated mPAO dimer¹ | 10.14 | 7.37 | 2.77 |
| (g) | | | |
| Crosslinker 100 (g) | 5.00 | | 5.00 |
| M201 1,6-HDDMA (g) | 0.37 | 0.37 | |
| SIP6831.2 (g) | 0.03 | 0.03 | |
| ISAN | | | |
| mol % M201 | 7.50 | 7.77 | 7.77 |

¹F-1-a

The procedure for the study was as follows: The reagent is 85:15, MX 200 (g) is 10.625, Part A (g) is 1.875 and Part (B) is 1.875. 0). Make Part A and Part B (as per Table 6).

1) Add 1.875 g Part A, 0.06 g ISAN and 10.625 g MX200 and speedmix at 1000 RPM for 1 min. Stir with wood stick and remix.
2) Add 1.875 g Part B, 0.06 g ISAN and 10.625 g MX200 and speedmix at 1000 RPM for 1 min. Stir with wood stick and remix.
3) Add 10 g of filled part A and 10 g of filled part B together and mix at 1000 RPM for 1 min. 3a) Pull vacuum on the sample (IC #27) until the air is removed.
4) Fill a mold for thermal conductivity measurements and allow to cure. Thermal conductivity was measured to be 1.56 W/m·K. Shore OO was measured to be 75 at RT. The Shore OO hardness test is at room temperature using a Shore OO Scale Ergo Durometer 411 according to ASTM D2240 by PTC Instruments (Los Angeles, Calif.).

### Example 4: ATH Filler Study for Thermal Conductivity with 7.5% Crosslinker

Thermal conductivity was measured of an Inventive Composition #28 (IC #28) formulated with an ATH at 80:20 with PAO-silicone hybrid resin and 7.5% HDDMA crosslinker.

TABLE 7

| | PAO-SiH | | |
|---|---|---|---|
| Reagent | resin hybrid #2 | Part A | Part B |
| Unsaturated mPAO | 10.14 | 7.37 | 2.77 |
| dimer¹ (g) | | | |
| Crosslinker 100 (g) | 5.00 | | 5.00 |
| M201 1,6-HDDMA (g) | 0.37 | 0.37 | |
| SIP6831.2 (g) | 0.03 | 0.03 | |
| ISAN | | | |
| mol % M201 | 7.50 | 7.77 | 7.77 |

### F-1a Procedure:

### 0) Make Part A and Part B (as per Table 7).

1) Add 2.5 g Part A and 10.0 g MX200 and speedmix at 1000 RPM for 1 min. add 0.06 g ISAN and remix.
2) Add 2.5 g Part B and 10.0 g MX200 and speedmix at 1000 RPM for 1 min. add 0.06 g ISAN and remix.
3) Add 10 g of filled part A and 10 g of filled part B together and mix at 1000 RPM for 1 min.
3a) Pull vacuum on the sample (IC #28) until the air is removed.
4) Fill a mold for thermal conductivity measurements and allow to cure.

Thermal conductivity was measured to be 1.54 W/m·K. Shore OO was measured to be 65 at RT. The Shore OO hardness test is at room temperature using a Shore OO Scale Ergo Durometer 411 according to ASTM D2240 by PTC Instruments (Los Angeles, Calif.).

### Example 5—Impact of ISAN Level on Hydrosilation Cure

A study was conducted to investigate the impact of ISAN level of hydrosilation cure. IC #25 from Example 2 was compared to Inventive Compositions #29 and #30 as set forth in Table 8.

TABLE 8

| Reagent | Mw (g/mol) | EW | IC# 25 | IC # 29 | IC #30 |
|---|---|---|---|---|---|
| Unsaturated mPAO dimer¹ (g) | 280.53 | 280.53 | 10.14 | 10.14 | 10.14 |
| Crosslinker 100 (g) | 11600 | 128.00 | 5.00 | 5.00 | 5.00 |
| M201 1,6-HDDMA (g) | 254.32 | 127.16 | 0.37 | 0.37 | 0.37 |
| Iso-stearic Acid N (g) | — | — | 0.19 | 0.38 | 0.76 |
| SIP6831.2 (g) | — | — | 0.03 | 0.03 | 0.03 |
| Weight % Dispersant | — | — | 0.5 | 1.00 | 2.00 |
| 24 hr Shore OO | | | 0 | Liquid | Liquid |
| 48 hr + 1 hr 80° C. Shore OO | | | 0 | 0 | Liquid |

¹F-1-a

At a Pt level of 0.03 in compositions as set forth in Table 8, 1% is the limit for ISAN to prevent curing issues based upon the Shore hardness results set forth in Table 8.

### Example 6—Dispensing Studies

This example provides a comparison of 85:15 filled systems using a hybrid silicone-PAO resin having a ratio of uPAO dimer:HDDMA of 7.37:0.37 with:

a. no ISAN additive (Comparative Composition #3a (CC #3a))
b. ISAN added (Inventive Composition #31 (IC #31)).

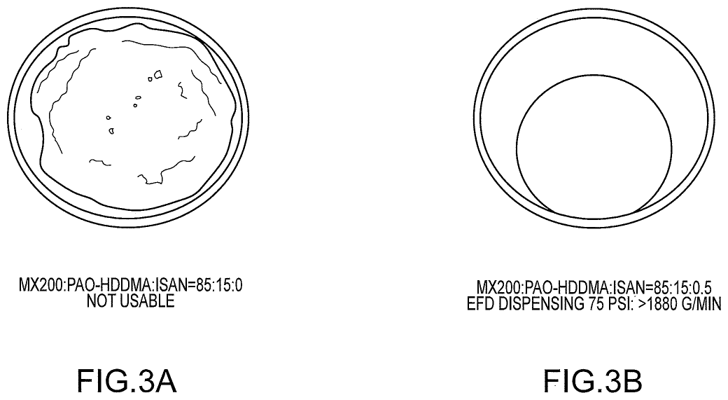

The ratio of MX200:PAO-HDDMA:ISAN was 85:15:0 for CC #3a. The ratio of MX200:PAO-HDDMA:ISAN was 85:15:0.5 for IC #31. FIG. 3A show CC #3a (no additive) after mixing. FIG. 3B show IC #31 (ISAN added as an additive). ISAN added as an additive significantly improved dispensing. Whereas CC #3a (no ISAN additive) is not usable, EFD dispensing for IC #31 (ISAN added as an additive) was 75 psi: >1880 g/min.

### Example 7—Silicone-ATH System: Rheology

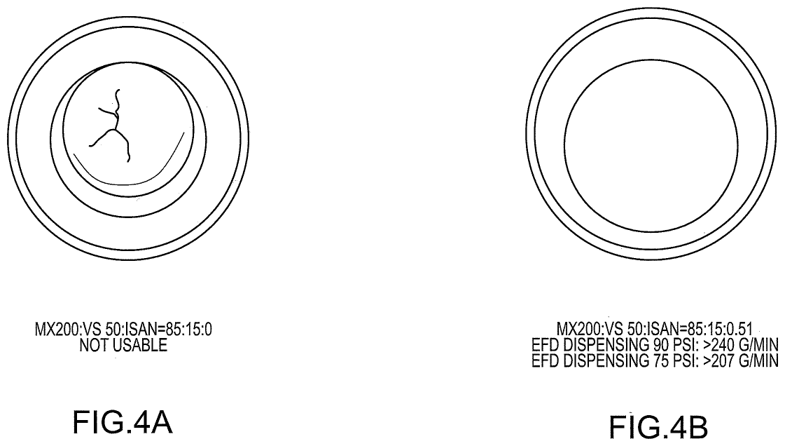

This example provides a comparison of the effect of ISAN on the rheology of a silicone-ATH system where the silicone is 50 cps divinyl terminated silicone (Polymer VS 50). A Comparative Composition #4 (CC #4) was formulated to have a ratio of MX200:VS 50:ISAN of 85:15:0. An Inventive Composition #32 (IC #32) was formulated to have a ratio of MX200:VS 50:ISAN of 85:15:0.51. CC #4 is shown in FIG. 4A. IC #57 is shown in FIG. 4B. ISAN significantly improved dispensing. Whereas CC #4 is not usable, the EFD dispensing rate of IC #32 at 90 psi was 240 g/min and the EFD dispensing rate at 75 psi was 207 g/min.

### Example 8—Silicone ATH System Thermal Conductivity

This example provides the thermal conductivity of a silicone-ATH system. ATH loading was at ˜85% (no alumina added) in an Inventive Composition #33 formulated as shown in Table 9. With ATH used on its own, thermal conductivity improved over a typical unfilled silicone rubber which has a thermal conductivity of approximately 0.2 W/m·K.

TABLE 9

| Name | Description | MW | EW | Part A | Part B |
|---|---|---|---|---|---|
| HMS-301 | methylhydridosiloxane- | | 245 | 0.196 | |
| (supplied by Gelest) | dimethylsiloxane copolymer | | | | |
| MCR-V21 | monodisperse mono-vinyl PDMS | 6,000 | 6,000 | 2.3 | 2.15 |
| (supplied by Gelest) | | | | | |
| DMS-V21 | Vinyl terminated PDMS | 6,000 | 3,000 | | 0.35 |
| (available from | | | | | |
| Gelest) | | | | | |
| SIP6831.2LC | Pt catalyst (2% in xylene) | n/a | n/a | | 0.007 |
| (available from | | | | | |
| Gelest) | | | | | |
| ISAN | | | | 0.113 | 0.120 |
| (available from | | | | | |
| Nissan Chemical | | | | | |
| America) | | | | | |
| ATH MX200 | | | | | |
| (available from RJ | | | | 14.17 | 14.16 |
| Marshall) | | | | | |

| | |
|---|---|
| ATH loading (wt %) | 84.4 wt % |
| TC (W/m*K) | 1.34 |

### Example 9—Scoping Acids Additives

A Part A resin having a ratio of unsaturated mPAO dimer:HDDMA of 7.37:0.37 was formulated. The initial viscosity was 238,000 cps @ 25° C. for an 80:20 mix of MX200: Part A resin. Eight formulations were prepared. Additive was added at 0.5% based on total formulation to form Inventive Compositions (ICs) #1, #34 to #40. An additive #1 to #8, respectively, as shown in Table 10, was added at 0.5% based on total formulation to form Inventive Compositions (ICs) #1, #34 to #40, respectively. All acids set forth in Table 10 resulted in significant viscosity reduction. Without wishing to be bound by any particular theory, all the dispersing additives shown in Table 10 are believed to work by lowering the viscosity and will likely all be miscible so cure will not be affected.

TABLE 10

| | 1 | 2 | 3 | 4 |
|---|---|---|---|---|
| IC# | #1 | #34 | #35 | #36 |
| Name | Isosteric | 2-Hexyl | 2-Butyl | Cyclopentane |
| | acid-N | decanoic acid | octanoic acid | propionic acid |
| Structure | 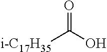 | 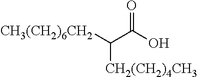 | 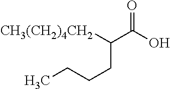 | 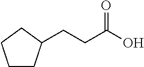 |
| CAS# | 30399-84-9 | 25354-97-6 | 27610-92-0 | 140-77-2 |
| Visc. at 10 | 9640 | 9900 | 8475 | 9562 |
| rpm (cps) | | | | |
| Appearance | Wet paste | Wet paste | Wet paste | Wet paste |
| | 5 | 6 | 7 | 8 |
| IC# | #37 | #38 | #39 | #40 |
| Name | 4-Dodecyl | Perfluoro | Nonafluoro | Bis(2,4,4-trimethylpentyl) |
| | Benzene sulfonic acid | heptanoic acid | butane-1-sulfonic acid | phosphinic acid |
| Structure | 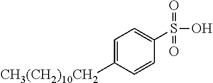 | 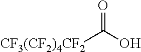 | 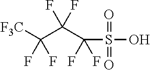 [SMILES: O=S(=O)(O)C(F)(F)C(F)(F)C(F)(F)C(F)(F)F] | 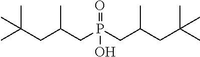 [SMILES: CC(CC(C)(C)C)CP(=O)(O)CC(C)CC(C)(C)C] |
| CAS# | 121-65-3 | 375-85-9 | 375-73-5 | 83411-71-6 |
| Visc. at 10 | 9975 | 10950 | 12975 | 9075 |
| rpm (cps) | | | | |
| Appearance | Wet paste | Wet paste | Wet paste | Wet paste |

### Example 10—Effect of ISAN on Untreated Aluminum Oxide

Three compositions including filler:resin in a ratio of 100:8 were formulated as shown in Table 11, i.e., Comparative Composition #5 and Inventive Compositions #41 and #42.

TABLE 11

| | CC #5 | #IC #41 | #IC #42 |
|---|---|---|---|
| Untreated spherical and | 100 | 100 | 100 |
| irregular alumina blend of | | | |
| various grades (Denka) | | | |
| DMS-V25 (500 cps silicone) | 8 | 8 | 8 |
| (available from Gelest) | | | |
| ISAN (available from | 0 | 0.2 | 0.5 |
| Nissan Chemical America) | | | |
| EFD dispensing (g/min, 75 psi) | Not usable | 30.6 | 38.1 |

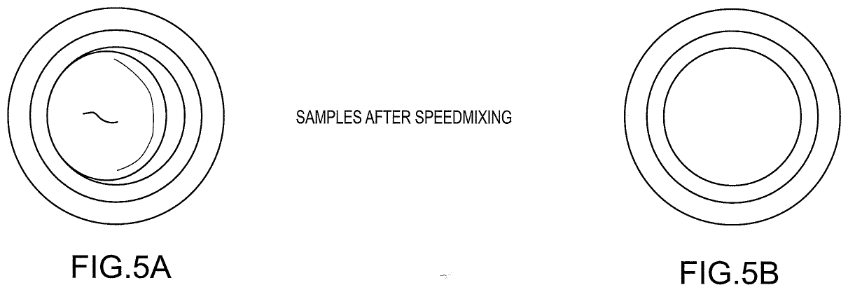

As is evident from the results in Table 11, CC #5, which did not include ISAN, was not usable. Inventive Compositions #41 and #42, which each included ISAN, were usable, with dispensing rates as shown in Table 12. CC #5 is shown in FIG. 5A. IC #42 is shown in FIG. 5B.

What is claimed is:

1. A thermally conductive composition comprising:
(a) a silicone or silicone-hybrid resin matrix;
(b) a conductive filler comprising an aluminum oxide-containing particle; and
(c) a liquid organic acid soluble in the matrix.

2. The conductive composition of claim 1, further including:
(d) a hydrosilation catalyst; and
(e) a crosslinker.

3. The conductive composition of claim 1, wherein the matrix of (a) is a silicone or silicone-hybrid that is curable or non-curable.

4. The conductive composition of claim 1, wherein the conductive filler of (b) comprises aluminum trihydroxide, with or without alumina.

5. The conductive composition of claim 1, wherein the conductive filler of (b) comprises aluminum trihydroxide and alumina.

6. The conductive composition of claim 1, wherein the conductive filler of (b) comprises aluminum trihydroxide and alumina in a by weight ratio of about 95:5 to about 5:95.

7. The conductive composition of claim 1, wherein the weight ratio of conductive filler of (b) to resin matrix is present about 95:5 to about 5:95.

8. The conductive composition of claim 1, wherein the conductive filler of (b) is present in an amount of about 50 to about 95 weight percent.

9. The conductive composition of claim 1, wherein the conductive filler of (b) is present in an amount of about 70 to about 90 weight percent.

10. The conductive composition of claim 1, wherein the liquid organic acid of (c) is a carboxylic acid.

11. The conductive composition of claim 1, wherein the liquid organic acid of (c) is a fluorinated carboxylic acid.

12. The conductive composition of claim 1, wherein the liquid organic acid of (c) is a phosphorous-containing acid or a sulfur-containing acid.

13. The conductive composition of claim 1, wherein the liquid organic acid of (c) is a member selected from the group consisting of Iso-stearic Acid N, 2-hexyl decanoic acid, 2-butyl octanoic acid, cyclopentane octanic acid, 4-dodecyl sulfonic acid, perfluoro heptanoic acid, nonafluoro butane-1-sulfonic acid, bis(2,4,4-)trimethylpentylphosphinic acid and combinations thereof.

14. The conductive composition of claim 1, wherein the liquid organic acid of (c) is present in an amount of about 0.01 to about 5 weight percent based on the total combined formulation.

15. The conductive composition of claim 1, in a flowable form.

16. The conductive composition of claim 1, having a viscosity, at 1/sec shear rate, of less than about 1500 Pa·s.

17. The conductive composition of claim 1, having a thermal conductivity of up to about 20 W/m·k.

18. The conductive composition of claim 1, wherein the conductive filler of (b) comprises alumina.

19. The conductive composition of claim 1, wherein the liquid organic acid is Disperbyk 108.
